(19) United States
(12) Patent Application Publication
(10) Pub. No.: US 2023/0348242 A1
(43) Pub. Date: Nov. 2, 2023

(54) HOIST SYSTEM

(71) Applicant: ATLANTA RIGGING & STAGING SERVICES, LLC, Atlanta, GA (US)

(72) Inventors: Neil Montour, Mableton, GA (US); Erik Jarvi, Woodstock, GA (US)

(21) Appl. No.: 17/733,304

(22) Filed: Apr. 29, 2022

(51) Int. Cl. B66D 3/20

(52) U.S. Cl. CPC B66D 3/20

(57) ABSTRACT

A hoist system for moving loads is encompassed by the present disclosure. The hoist system comprises a load line operably connected to a load sheave that is operably connected to a hoist drive shaft. The hoist drive shaft is operably connected to a coupler that is operably connected to a synchronous motor. The coupler comprises two coupler sockets, one of which is operably connected to the motor drive shaft and the other of which is operably connected to the hoist drive shaft.

### TECHNICAL FIELD

The present disclosure is directed generally to hoist systems, and, more specifically, to electric-powered hoist systems.

### BACKGROUND

Entertainment venues, such as theaters, conference centers, arenas, and outdoor stages, often employ electric hoists to move sets, lighting, sound system components, and other equipment. Due to space limitations in such venues and the significant weight of such components, there is a need for hoists that are compact, robust and able to be precisely controlled while moving loads at a wide range of speeds. Prior attempts to address these issues resulted in hoist manufacturers offering hoist systems that included custom-wound asynchronous motors with encoders. Such hoist systems often suffer from poor performance at low speeds and are susceptible to overheating. Consequently, there is a need for a hoist system that can potentially address one or more of these needs, while avoiding or minimizing the disadvantages of conventional hoist systems.

### SUMMARY

The present disclosure encompasses hoist systems having electric-powered synchronous motors. The present disclosure encompasses a hoist system comprising: a hoist system housing; a load sheave mounted in the hoist system housing; a load line operably engaged with the load sheave; a hoist drive shaft operably connected to the load sheave; a coupler operably connected to the hoist drive shaft, wherein the coupler comprises a first coupler end and a second coupler end opposing the first coupler end, wherein the coupler further comprises a first coupler socket open to the first coupler end and a second coupler socket open to the second coupler end, wherein the second coupler socket comprises a key slot, and wherein at least a portion of the hoist drive shaft is disposed in the first coupler socket; and, a synchronous motor operably connected to the coupler, wherein the synchronous motor comprises a motor drive shaft operably connected to the coupler, wherein the motor drive shaft comprises a key bit, wherein at least a portion of the motor drive shaft is disposed in the second coupler socket, and wherein at least a portion of the key bit is aligned in the key slot.

In one aspect, the coupler can comprise a plurality of coupler splines projecting inwardly from a first coupler socket inner wall. In another aspect, the hoist drive shaft can comprise a plurality of shaft splines projecting radially from the hoist drive shaft, and wherein the plurality of shaft splines mates with the plurality of coupler splines. In a further aspect, the coupler can comprise a first coupler end outer wall and a second coupler end outer wall, wherein the first coupler end outer wall comprises a first coupler end outer wall diameter and the second coupler end outer wall comprises second coupler end outer wall diameter, and wherein the first coupler end outer wall diameter is less than the second coupler end outer wall diameter. In yet another aspect, the hoist drive shaft, the coupler and the synchronous motor can be disposed in the hoist system housing. In still a further aspect, the first socket can be in communication with the second socket. In another aspect, the synchronous motor can be operable under natural convection with the load line supporting a load of about 1,000 kg. In still another aspect, the load line can be movable under a load in a range of about 0 kg to about 1,000 kg at a speed in a range of about 0 m/min to about 20 m/min. In a further aspect, the load line can be movable under a load in a range of about 0 kg to about 500 kg at a speed in a range of about 0 m/min to about 40 m/min.

The present disclosure also encompasses a hoist system comprising: a load sheave; a load line operably engaged with the load sheave; a hoist drive shaft operably connected to the load sheave, and wherein the hoist drive shaft comprises a plurality of shaft splines projecting radially; a coupler connected to the hoist drive shaft, wherein the coupler comprises a first coupler end and a second coupler end opposing the first coupler end, the coupler further comprises a first coupler socket open to the first coupler end and a second coupler socket open to the second coupler end, wherein the first coupler socket comprises a plurality of coupler splines projecting inwardly from a first coupler socket inner wall; and wherein the second coupler socket comprises a key slot formed in a second coupler socket inner wall, and wherein a portion of the hoist drive shaft is aligned in the first coupler socket; and, a synchronous motor connected to the coupler, wherein the synchronous motor comprises a motor drive shaft connected to the coupler, wherein the motor drive shaft comprises a key bit, wherein a portion of the motor drive shaft is aligned in the second coupler socket, and wherein the key bit is aligned in the key slot.

In one aspect the hoist system can further comprise a hoist system housing, wherein the load sheave, the hoist drive shaft, and the coupler are disposed in the hoist system housing. In another aspect, the synchronous motor can be disposed in the hoist system housing. In a further aspect, the coupler can comprise a first coupler end outer wall and a second coupler end outer wall, wherein the first coupler end outer wall comprises a first coupler end outer wall diameter and the second coupler end outer wall comprises second coupler end outer wall diameter, and wherein the first coupler end outer wall diameter is less than the second coupler end outer wall diameter. In yet another aspect, the synchronous motor can be operable under natural convection at a maximum duty cycle of about 100% with the load line supporting a load of about 1,000 kg. In still a further aspect, the load line can be movable under a load in a range of about 0 kg to about 1,000 kg at a speed in a range of about 0 m/min to about 20 m/min. In another aspect, the load line can be movable under a load in a range of about 0 kg to about 500 kg at a speed in a range of about 0 m/min to about 40 m/min.

The present disclosure also encompasses a hoist system comprising: a hoist system housing; a load sheave disposed in the hoist system housing, a load line operably engaged with the load sheave; a hoist drive shaft operably connected to the load sheave, and wherein the hoist drive shaft comprises a plurality of shaft splines projecting radially from the hoist drive shaft; a coupler connected to the hoist drive shaft, wherein the coupler comprises a first coupler end and a second coupler end opposing the first coupler end, wherein coupler comprises a first coupler end outer wall and a second coupler end outer wall, wherein the first coupler end outer wall comprises a first coupler end outer wall diameter and the second coupler end outer wall comprises second coupler end outer wall diameter, wherein the first coupler end outer wall diameter is less than the second coupler end outer wall diameter, wherein the coupler further comprises a first coupler socket open to the first coupler end and a second coupler socket open to the second coupler end, wherein the first coupler socket comprises a plurality of coupler splines projecting inwardly from a first coupler socket inner wall; wherein the second coupler socket comprises a key slot formed in a second coupler socket inner wall, and wherein a portion of the hoist drive shaft is aligned in the first coupler socket and the plurality of shaft splines mates with the plurality of coupler splines; and, a synchronous motor connected to the coupler, wherein the synchronous motor comprises a motor drive shaft connected to the coupler, wherein the motor drive shaft comprises a key bit, wherein a portion of the motor drive shaft is aligned in the second coupler socket, and wherein the key bit is aligned in the key slot.

In one aspect, the first coupler socket inner wall can comprise a first coupler socket inner wall diameter and the second coupler socket inner wall comprises a second coupler socket inner wall diameter, and wherein the second coupler socket inner wall diameter is greater than the first coupler socket inner wall diameter. In another aspect, the load line can be movable under a load in a range of about 0 kg to about 1000 kg at a speed in a range of about 0 m/min to about 20 m/min. In a further aspect, the load line can be movable under a load in a range of about 0 kg to about 500 kg at a speed in a range of about 0 m/min to about 40 m/min.

The present disclosure also encompasses a coupler for a hoist system wherein the coupler operably connects a synchronous motor to a load sheave of the hoist system so as to drive the movement of a load line of the hoist system. The coupler comprises a first coupler end and a second coupler end opposing the first coupler end, the coupler further comprises a first coupler socket open to the first coupler end and a second coupler socket open to the second coupler end, wherein the first coupler socket comprises a plurality of coupler splines projecting inwardly from a first coupler socket inner wall; and wherein the second coupler socket comprises a key slot formed in a second coupler socket inner wall. In one aspect, the coupler can comprise a first coupler end outer wall and a second coupler end outer wall, wherein the first coupler end outer wall comprises a first coupler end outer wall diameter and the second coupler end outer wall comprises second coupler end outer wall diameter, and wherein the first coupler end outer wall diameter is less the second coupler end outer wall diameter.

These and other aspects of the present disclosure are set forth in greater detail below and in the drawings for which a brief description is provided as follows.

### BRIEF DESCRIPTION OF THE DRAWINGS

FIG. 1 is a perspective view of a hoist system encompassing aspects of the present disclosure.

FIG. 2 is a perspective view of the hoist system of FIG. 1 with the hoist system housing motor cover removed to expose the synchronous motor.

FIG. 3 is a perspective view of the synchronous motor shown in FIG. 2 removed from the other components of the hoist system.

FIG. 4 is a side elevation view of the synchronous motor shown in FIG. 3.

FIG. 5 is perspective view of a coupler of the hoist system shown in FIG. 1 removed from the other components of the hoist system.

FIG. 6 is an end view of the coupler shown in FIG. 5.

FIG. 7 is a cross-sectional view of the coupler shown in FIG. 6 taken along line 7-7.

FIG. 8 is a side view of the hoist drive shaft of the hoist system shown in FIG. 1 with the hoist drive shaft separated from the other components of the hoist system.

FIG. 9 is a side view of the coupler shown in FIG. 5 connected to the hoist drive shaft shown in FIG. 8.

FIG. 10 is a side view of the coupler and the hoist drive shaft shown in FIG. 9 with the synchronous motor shown in FIG. 3 connected to the coupler.

FIG. 11 is a side view of the hoist system shown in FIG. 1 with part of the system removed to show interior of the hoist stem housing and the movable engagement of the load line and load sheave.

### DETAILED DESCRIPTION

The present disclosure encompasses hoist systems driven by electric-powered synchronous motors. The synchronous motors of the hoist systems of the present disclosure are operably connected to the gear systems of the hoist systems by double-socket couplers that connect the motor drive shafts of the synchronous motors to hoist shafts that operably connect to the gear systems that control the movements of the load sheaves and the load lines that are operably engaged with the load sheaves. The present disclosure encompasses hoist systems that can lift, under natural convection, loads in the range of about 0 kg to about 500 kg at speeds in a range from about 0 m/minute to about m/minute. The present disclosure also encompasses hoist systems that can lift, under natural convection, loads in the range of about 0 kg to about 1,000 kg at speeds in a range from about 0 m/minute to about 20 m/minute. The hoist systems of the present disclosure can move such loads in such ranges of speed without the use of forced convection to cool the motor and hoist components. The hoist systems of the present disclosure can operate at zero speed (0 m/min) and near zero speed, measured in mm/min, under loads in the range of about 0 kg to about 500 kg and/or about 0 kg to about 1,000 kg without overheating under natural convection and in the absence of forced convection. Wherever possible, the application uses the same reference numbers throughout the drawings to refer to the same or similar items.

As used herein, the singular forms of “a,” “an,” and “the” encompasses the plural form thereof unless otherwise indicated. As used herein, the phrase “at least one” includes all numbers of one and greater. As used herein, the phrase “at least a portion of” includes less than the entirety of a component and/or the entirety of a component. As used herein, the term “natural convection” refers to circulation of a fluid, such as air, adjacent a solid boundary due to the density difference resulting from the temperature variation throughout a region of the fluid, and does not include fluid circulation generated by forced convection. As used herein, the term “forced convection” refers to circulation of fluid, such as air, past a solid surface by a human-designed external source. Examples of a “human-designed external source” include, but are not limited to, a fan, a pump, a negative pressure system, etc. As used herein, “kg” refers to the mass unit—kilogram. As used herein, “m” refers to the unit of length—meter. As used herein, “mm” refers to the unit of length—millimeter. As used herein, “min” refers to the unit of time—minute. As used herein, the term “operably engaged to” encompasses configurations of elements such that one element or portion thereof contacts or otherwise interacts with another element so as to allow the two elements to functionally cooperate in the intended fashion within the apparatus. As used herein, the term “operably connected” encompasses configurations of elements wherein one element is connected directly and/or indirectly to another element so as to allow the two elements to function in the intended fashion within the apparatus. As used herein, the term “in communication” refers to the direct or indirect opening or passage between one element and another element. As used herein, the term “duty cycle” is the proportion of time during which the hoist system is configured to be operated and is expressed as a percentage.

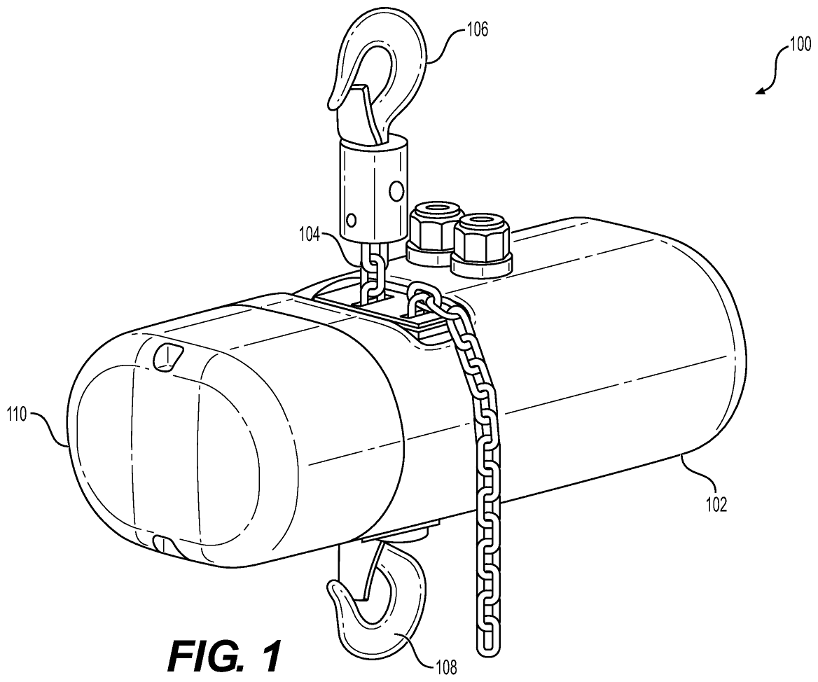

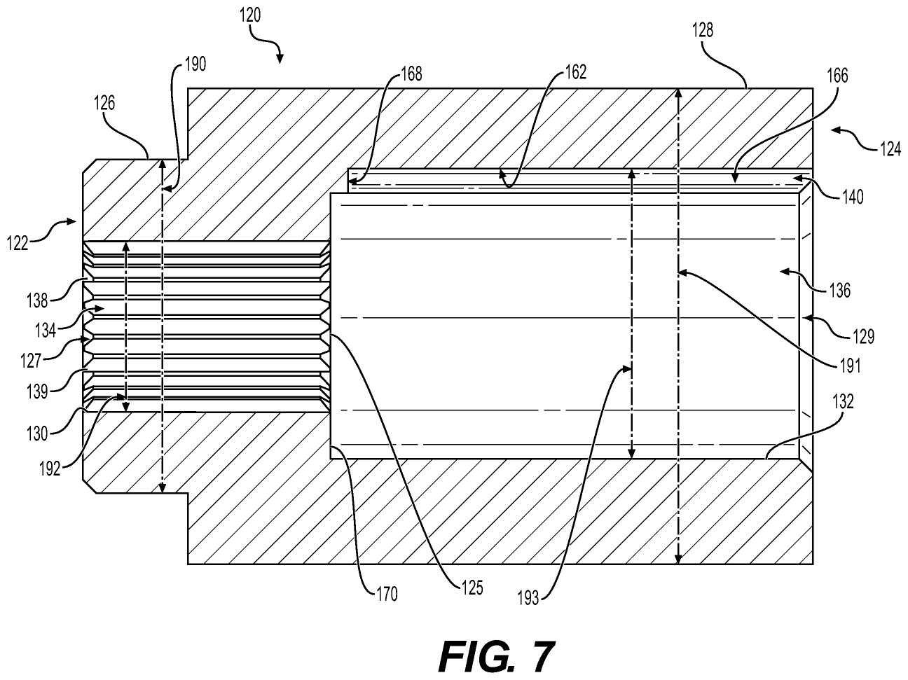

FIGS. 1-11 illustrate a hoist system 100, and parts thereof, encompassing aspects of the present disclosure. The hoist system 100 comprises a load line 104 operably engaged to a load sheave 150 that is rotatably mounted within the hoist system housing 102. The load line 104 moves in one direction or another with the direction of rotation of the load sheave 150. The rotation of the load sheave 150 is controlled by a synchronous motor 112 that is operably connected thereto by a coupler 120 and a hoist drive shaft 180. The coupler 120 joins together the motor drive shaft 114 and the hoist drive shaft 180, which is operably connected to a gear system 165, which the controls the rotation of the load sheave 150.

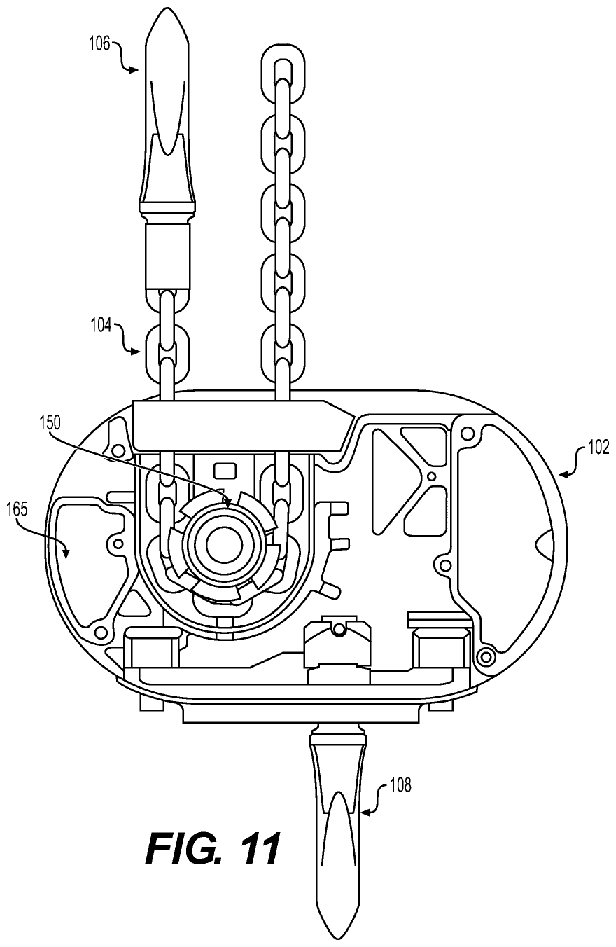

As shown in FIG. 1, the load line 104 is configured to feed through two ports formed in the hoist system housing 102. The load line 104, shown in FIGS. 1 and 11, is illustrated as a chain comprising a series of interlocking metal links. The present disclosure encompasses hoist systems that comprise a load line in the form of a cable or rope formed of metal and/or polymeric material. The cable or rope can be formed of a plurality of intertwined wires, threads or the like.

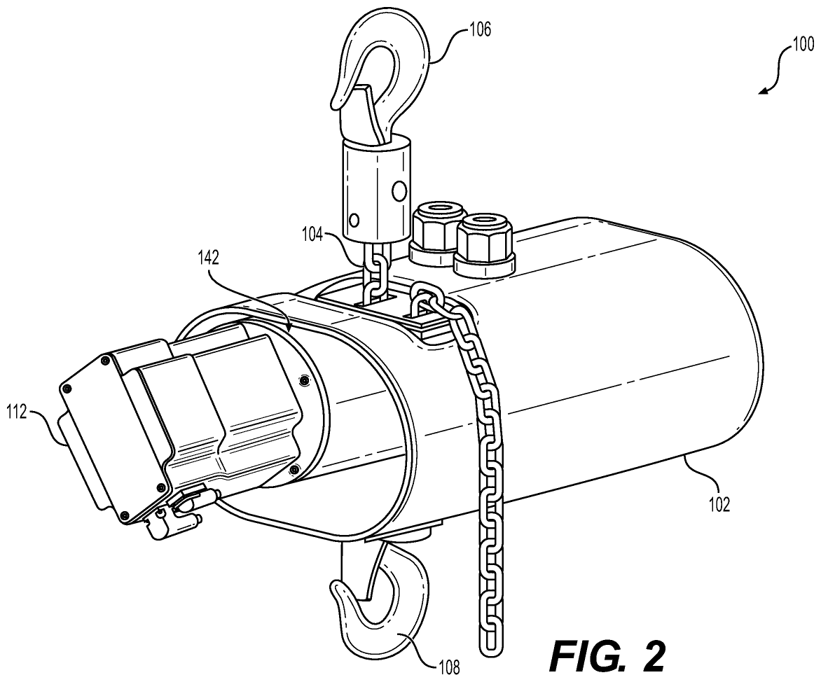

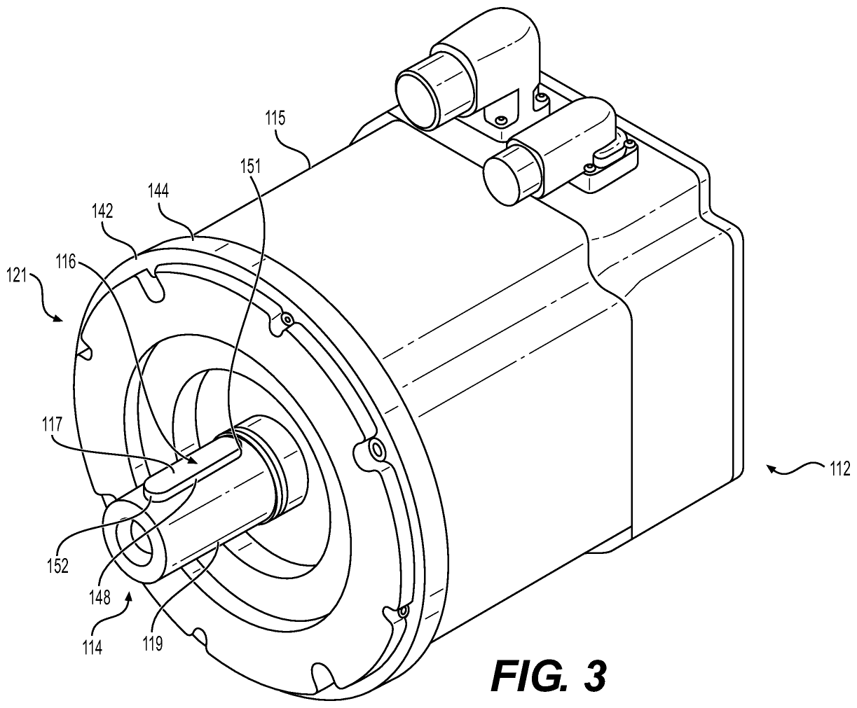

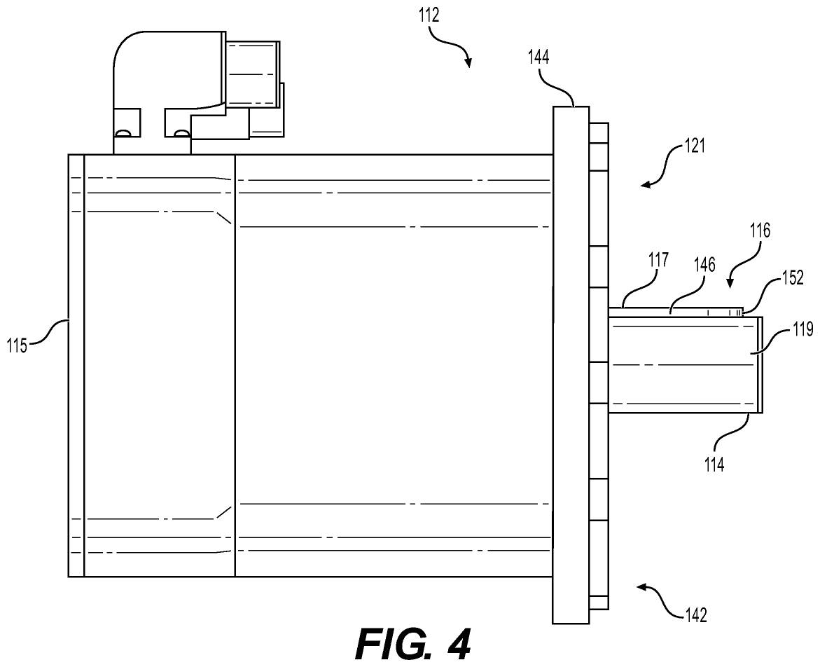

As shown in FIGS. 1 and 2, the synchronous motor 112 is disposed in the hoist system housing 102 and enclosed therein by the motor cover 110, which is removably attached to the remainder of the hoist system housing 102. As shown in FIGS. 3 and 4, the synchronous motor 112 comprises an output flange 142 that comprises a flange outer wall 144 that is generally circular. The output flange 142 is mounted on the synchronous motor body 115 on the output side 121 thereof. In one aspect, the outer wall diameter of the output flange 142 can be about 174 mm. The diameter of the synchronous motor body 115 is less than or equal to the outer wall diameter of the output flange 142. With the motor body diameter being no greater than the diameter of the output flange 142, the synchronous motor 112 can fit into the hoist system housing 102.

The synchronous motor 112 comprises a motor drive shaft 114 that extends outward from output side 121 of the synchronous motor body 115. The motor drive shaft 114 extends through the output flange 142. A key bit 116 is mounted on and/or projects from the motor drive shaft 114 and extends outward from the motor drive shaft side wall 119. The key bit 116 comprises, a first key bit side wall 146, a second key bit side wall 148 opposing the first key bit side wall 146, and a key bit top wall 117 that extends between the first key bit side wall 146 and the second key bit side wall 148. Each of the first key bit side wall 146, the second key bit side wall 148 and the key bit top wall 117 are flat. The key bit 116 also comprises a first key bit end wall 151 and a second key bit end wall 152. Each of the first key bit end wall 151 and the second key bit end wall 152 is arcuate and extends between the first key bit side wall 146 and the second key bit side wall 148. The first key bit end wall 151 is aligned proximal to the synchronous motor body 115, and the second key bit end wall 152 is aligned distal to the synchronous motor body 115.

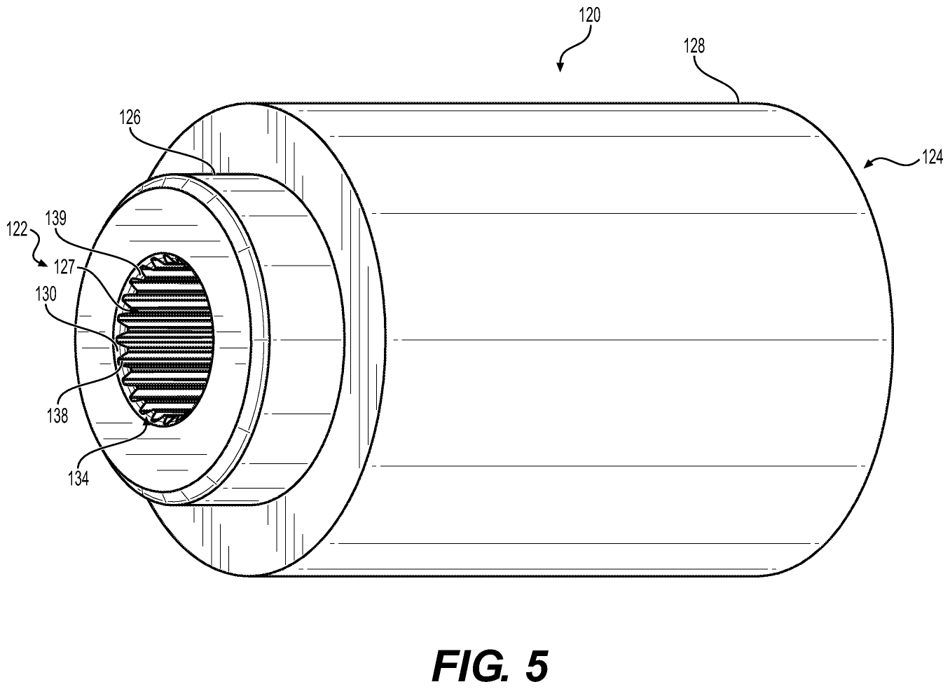

As shown in FIGS. 5-7, the coupler 120 comprises a first coupler end 122 and a second coupler end 124 opposing the first coupler end 122. Both of the first coupler end 122 and the second coupler end 124 are cylindrical. The first coupler end 122 comprises a first coupler end outer wall 126, and the second coupler end 124 comprises a second coupler end outer wall 128. The first coupler end outer wall 126 has first coupler end outer wall diameter 190, and the second coupler end outer wall 128 has a second coupler end outer wall diameter 191. The second coupler end outer wall diameter 191 is greater than the first coupler end outer wall diameter 190, thereby allowing for the coupler 120 to fit into the available space within the hoist housing 102.

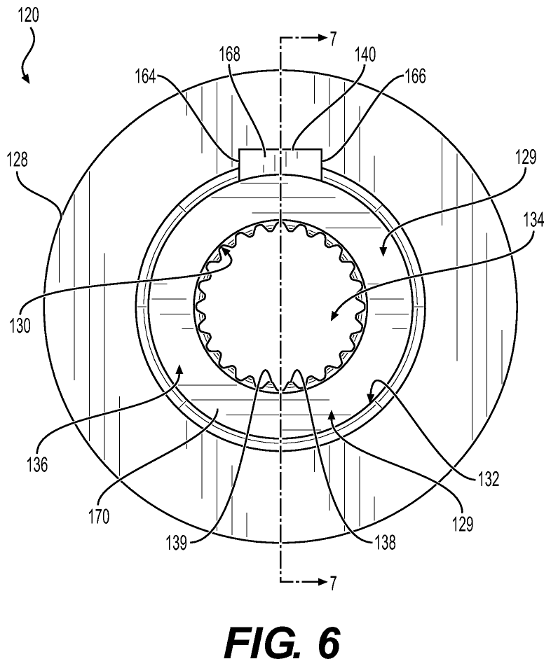

The coupler 120 has a coupler channel 125 that extends through the entire coupler 120 from a first coupler end opening 127 to the second coupler end opening 129. The coupler 120 comprises a first coupler socket 134 formed in the first coupler end 122 and a second coupler socket 136 formed in the second coupler end 124. The first coupler socket 134 is in communication with the first coupler end opening 127 and comprises a first coupler end inner wall 130. The first coupler socket 134 also comprises a plurality of coupler splines 138 disposed on and projecting inwardly from the first coupler socket inner wall 130. As shown in FIG. 6, each coupler spline 139 of the plurality of coupler splines 138 is involute. The first coupler socket 134 is in communication with the second coupler socket 136 through the interior of the coupler 120, thereby forming the coupler channel 125, which extends through the second coupler socket back wall 170.

The second coupler socket 136 comprises a second coupler socket inner wall 132 in which is formed a key slot 140. The key slot 140 comprises a first key slot side wall 164, a second key slot side wall 166 opposing the first key slot side wall 164, a key slot outer wall 162, and a key slot back wall 168. Each of the first key slot side wall 164, the second key slot side wall 166, the key slot outer wall 162, and the key slot back wall 168 are flat. The key slot 140 is sized to receive and cooperate with the key bit 116 on the motor drive shaft 114 to retain the key bit 116 within the key slot 140 and to turn the coupler 120 when the motor drive shaft 114 rotates.

The first coupler socket inner wall 130 has a first coupler socket inner wall diameter 192, and the second coupler socket inner wall inner wall 132 has a second coupler socket inner wall diameter 193. The first coupler inner wall diameter 192 is less than the second coupler socket inner wall diameter 193.

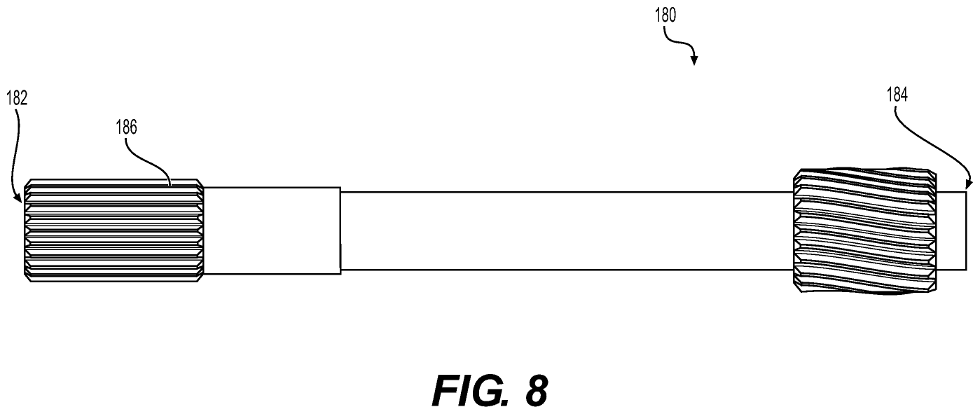

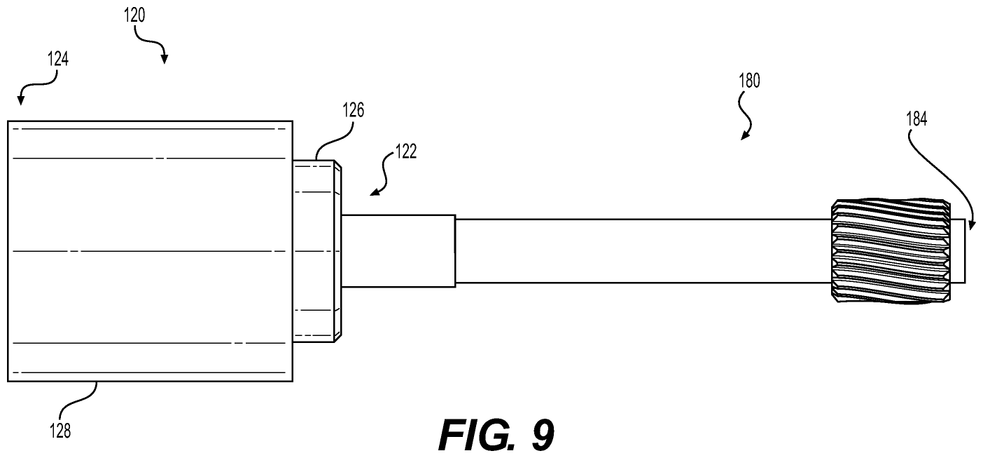

FIG. 8 shows the hoist drive shaft 180, which includes a first hoist drive shaft end 182 and a second hoist drive shaft end 184 opposing the first drive shaft end 182. A plurality of shaft splines 186 is disposed adjacent the first hoist drive shaft end 182. Each of the shaft splines is involute. The plurality of shaft splines 186 extends radially from the hoist drive shaft 180. As shown in FIG. 9, the first hoist drive shaft end 182 is disposed in the first coupler socket 134. The plurality of shaft splines 186 mates with the plurality of coupler splines 138, so as to connect the coupler 120 to the hoist drive shaft 180. The mating of the plurality of shaft splines 186 and the plurality of coupler splines 138 results in the hoist drive shaft 180 connecting to the coupler 120 such that the hoist drive shaft 180 rotates at the same speed and in the same direction as the coupler 120.

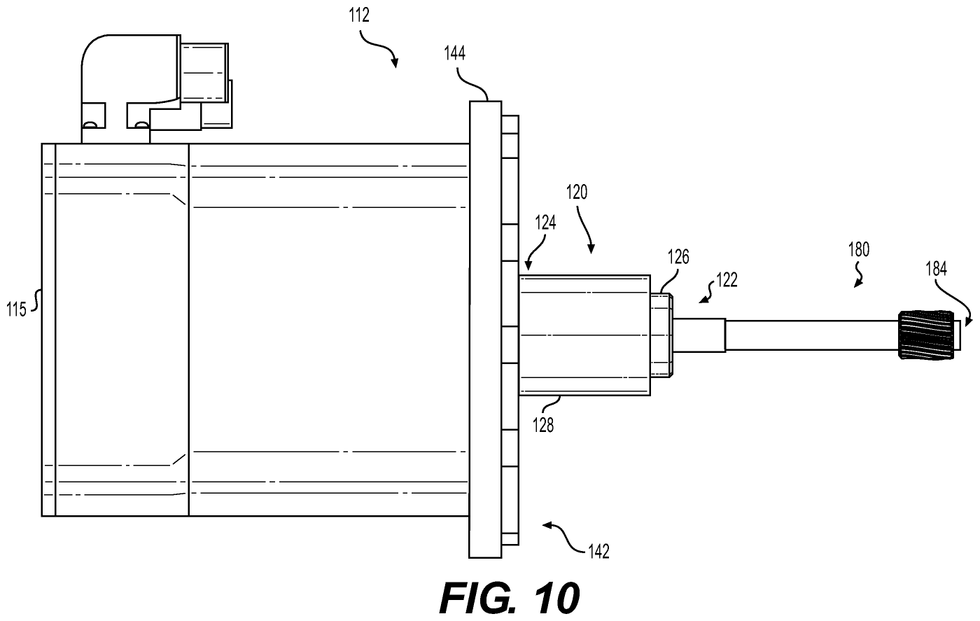

FIG. 10 shows the synchronous motor 112, the coupler 120 and the hoist drive shaft 180 connected to each other. At least a portion of the motor drive shaft 114 is disposed in the second coupler socket 136. The motor drive shaft 114 is connected to the coupler 120 by the mating of the key bit 116 with the key slot 114. When the motor drive shaft 114 rotates, whether clockwise or counterclockwise, the coupler 120 and the hoist drive shaft 180 rotate in the same direction and at the same speed as the motor drive shaft 114. The second hoist drive shaft end 184 is operably connected to the gear system 165, which, in turn, is operably connected to and controls the movement of the load sheave 150, shown in FIG. 11. Since the load line 104 operably engages the load sheave 150, as shown in FIG. 11, rotation of the motor drive shaft 114 results in the movement the load line 104.

The present disclosure encompasses hoist systems 100 that comprise some components of commercially available hoist systems, such as, for example, the CM-ET LODESTAR® model JJ hoist or the CM-ET LODESTAR® model LL hoist, both available from Columbus McKinnon Corporation of Getzville, New York, USA. The CM-ET LODESTAR® model JJ hoist is conventionally configured to have a maximum load capacity rating of about 500 kg, a lifting speed rating at 50 Hertz units of about 16.26 m/min, a lifting speed rating at 60 Hertz units of about 19.51 m/min, and a recommended duty cycle of about 40%. The CM-ET LODESTAR® model LL hoist is conventionally configured to have a maximum load capacity rating of about 1,000 kg, a lifting speed rating at 50 Hertz units of about 8.13 m/min, a lifting speed rating at 60 Hertz units of about 9.75 m/min, and a recommended duty cycle of about 40%.

One example of the hoist system 100 comprises a synchronous motor 112 that comprises a servomotor Dynamic Line 3/400 V model E1SMHKO-3419 with an ARS output flange, available from KEB America, Inc. of Shakopee, Minnesota, USA, combined with components of the CM-ET LODESTAR® model JJ, along with a coupler 120 and hoist drive shaft 180. This hoist system 100 surprisingly can lift loads in the range of about 0 kg to about 500 kg at a speed in a range of about 0 m/in to at a maximum of about 40 m/min with natural convection. This hoist system can operate on a duty cycle of about 100%.

Another example of the hoist system 100 comprises a synchronous motor 112 a servomotor Dynamic Line 3/400 V model E1SMHKO-3419 with an ARS output flange, a coupler 120 operably connected to the synchronous motor 112, a hoist drive shaft 180 operably connected to the other components of the CM-ET LODESTAR® model LL. This hoist system 100 surprisingly can lift loads in a range of about 0 kg to about 1,000 kg a speeds within a range of about 0/min to about 20 m/min with natural convection and no forced convection. This hoist system 100 can operate on duty cycle of about 100%. Surprisingly, the combination of a synchronous motor 112, as described, a coupler 120 operably connected to the synchronous motor 112, a hoist drive shaft 180 connected to the coupler 120 and with either components of the CM-ET LODESTAR® model JJ or the CM-ET LODESTAR® model LL can operate at increased maximum lift speeds under maximum loads in the absence of forced convection.

The motor drive shaft 114 can be about 32 mm in diameter and about 58 mm in length. The key bit 116 of the synchronous motor 112 can be about 10 mm in width, about 45 mm in length, and about 3 mm in height beyond the surface of the motor drive shaft side wall 119. The synchronous motor 112 can have a rated speed of 3000 rpm, a rated torque of about 11 Nm, a rated current of about 6.8 A, a system voltage of about 400 VAC, a standstill torque of about 12.6 Nm, and a standstill current of about 7.8 A. The synchronous motor 112 can comprise a socket encoder connection and be operably connected and controlled with an encoder.

In one example, the synchronous motor 112 can be a servomotor Dynamic Line 3/400 V model E1SMHKO-3419 with an ARS output flange, available from KEB America, Inc. of Shakopee, Minnesota, USA. Unlike the standard rectangular output flange on the face of the a traditional KEB America, Inc. dynamic line 3 synchronous motor, the ARS output flange 142 is circular with a face diameter less than the face cross-sectional distance of a similarly sized square output flanged traditional KEB America, Inc. dynamic line 3 synchronous motor.

In one aspect, the hoist system of the present disclosure can move a load in a range of about 0 kg to about 1,000 kg. In another aspect, the hoist system of the present disclosure can move a load in a range of about 0 kg to about 500 kg. In a further aspect, the upper limit of the range of the mass of the load that is movable by the hoist system of the present disclosure can be about 1,000 kg, 990 kg, 980 kg, 970 kg, 960 kg, 950 kg, 940 kg, 930 kg, 920 kg, 910 kg, 900 kg, 890 kg, 880 kg, 870 kg, 860 kg, 850 kg, 840 kg, 830 kg, 820 kg, 810 kg, 800 kg, 790 kg, 780 kg, 770 kg, 760 kg, 750 kg, 740 kg, 730 kg, 720 kg, 710 kg, 700 kg, 690 kg, 680 kg, 670 kg, 660 kg, 650 kg, 640 kg, 630 kg, 620 kg, 610 kg, 600 kg, 590 kg, 580 kg, 570 kg, 560 kg, 550 kg, 540 kg, 530 kg, 520 kg, 510 kg, 500 kg, 490 kg, 480 kg, 470 kg, 460 kg, 450 kg, 440 kg, 430 kg, 420 kg, 410 kg, 400 kg, 390 kg, 380 kg, 370 kg, 360 kg, 350 kg, 340 kg, 330 kg, 320 kg, 310 kg, 300 kg, 290 kg, 280 kg, 270 kg, 260 kg, 250 kg, 240 kg, 230 kg, 220 kg, 210 kg, 200 kg, 190 kg, 180 kg, 170 kg, 160 kg, 150 kg, 140 kg, 130 kg, 120 kg, 110 kg, 100 kg, 90 kg, 80 kg, 70 kg, 60 kg, 50 kg, 40 kg, 30 kg, 20 kg, or 10 kg.

In still another aspect, the lower limit of the range of the mass of the load that is movable by the hoist system of the present disclosure can be about 990 kg, 980 kg, 970 kg, 960 kg, 950 kg, 940 kg, 930 kg, 920 kg, 910 kg, 900 kg, 890 kg, 880 kg, 870 kg, 860 kg, 850 kg, 840 kg, 830 kg, 820 kg, 810 kg, 800 kg, 790 kg, 780 kg, 770 kg, 760 kg, 750 kg, 740 kg, 730 kg, 720 kg, 710 kg, 700 kg, 690 kg, 680 kg, 670 kg, 660 kg, 650 kg, 640 kg, 630 kg, 620 kg, 610 kg, 600 kg, 590 kg, 580 kg, 570 kg, 560 kg, 550 kg, 540 kg, 530 kg, 520 kg, 510 kg, 500 kg, 490 kg, 480 kg, 470 kg, 460 kg, 450 kg, 440 kg, 430 kg, 420 kg, 410 kg, 400 kg, 390 kg, 380 kg, 370 kg, 360 kg, 350 kg, 340 kg, 330 kg, 320 kg, 310 kg, 300 kg, 290 kg, 280 kg, 270 kg, 260 kg, 250 kg, 240 kg, 230 kg, 220 kg, 210 kg, 200 kg, 190 kg, 180 kg, 170 kg, 160 kg, 150 kg, 140 kg, 130 kg, 120 kg, 110 kg, 100 kg, 90 kg, 80 kg, 70 kg, 60 kg, 50 kg, 40 kg, 30 kg, 20 kg, 10 kg, 5 kg, or 0 kg. The present disclosure encompasses load ranges that include any of the aforementioned lower limits with any of the aforementioned upper limits.

In one aspect, the hoist system can move a load at a speed in a range of about 0 m/min to about 20 m/min. In another aspect, the hoist system can move a load at a speed in a range of about 0 m/min to about 40 m/min. In a further aspect, the upper limit of the speed range in which the hoist system of the present disclosure can move a load can be about 39.5 m/min, 39 m/min, 38.5 m/min, 38 m/min, 37.5 m/min, 37 m/min, 36.5 m/min, 36 m/min, 35.5 m/min, 35 m/min, 34.5 m/min, 34 m/min, 33.5 m/min, 33 m/min, 32.5 m/min, 32 m/min, 31.5 m/min, 31 m/min, 30.5 m/min, 30 m/min, 29.5 m/min, 29 m/min, 28.5 m/min, 28 m/min, 27.5 m/min, 27 m/min, 26.5 m/min, 26 m/min, 25.5 m/min, 25 m/min, 24.5 m/min, 24 m/min, 23.5 m/min, 23 m/min, 22.5 m/min, 22 m/min, 21.5 m/min, 21 m/min, 20.5 m/min, 20 m/min, 19.5 m/min, 19 m/min, 18.5 m/min, 18 m/min, 17.5 m/min, 17 m/min, 16.5 m/min; 16 m/min, 15.5 m/min, 15 m/min, 14.5 m/min, 14 m/min, 13.5 m/min, 13 m/min, 12.5 m/min, 12 m/min, 11.5 m/min, 11 m/min, 10.5 m/min, 10 m/min, 9.5 m/min, 9 m/min, 8.5 m/min, 8 m/min, 7.5 m/min, 7 m/min, 6.5 m/min, 6 m/min, 5.5 m/min, 5 m/min, 4.5 m/min, 4 m/min, 3.5 m/min, 3 m/min, 2.5 m/min, 2 m/min, 1.5 m/min, 1 m/min, or 0.5 m/min.

In yet another aspect, the lower limit of the speed range in which the hoist system of the present disclosure can move a load can be about 39.5 m/min, 39 m/min, 38.5 m/min, 38 m/min, 37.5 m/min, 37 m/min, 36.5 m/min, 36 m/min, 35.5 m/min, 35 m/min, 34.5 m/min, 34 m/min, 33.5 m/min, 33 m/min, 32.5 m/min, 32 m/min, 31.5 m/min, 31 m/min, 30.5 m/min, 30 m/min, 29.5 m/min, 29 m/min, 28.5 m/min, 28 m/min, 27.5 m/min, 27 m/min, 26.5 m/min, 26 m/min, 25.5 m/min, 25 m/min, 24.5 m/min, 24 m/min, 23.5 m/min, 23 m/min, 22.5 m/min, 22 m/min, 21.5 m/min, 21 m/min, 20.5 m/min, 20 m/min, 19.5 m/min, 19 m/min, 18.5 m/min, 18 m/min, 17.5 m/min, 17 m/min, 16.5 m/min; 16 m/min, 15.5 m/min, 15 m/min, 14.5 m/min, 14 m/min, 13.5 m/min, 13 m/min, 12.5 m/min, 12 m/min, 11.5 m/min, 11 m/min, 10.5 m/min, 10 m/min, 9.5 m/min, 9 m/min, 8.5 m/min, 8 m/min, 7.5 m/min, 7 m/min, 6.5 m/min, 6 m/min, 5.5 m/min, 5 m/min, 4.5 m/min, 4 m/min, 3.5 m/min, 3 m/min, 2.5 m/min, 2 m/min, 1.5 m/min, 1 m/min, 0.5 m/min, or 0 m/min. The present disclosure encompasses speed ranges that include any of the aforementioned lower limits with any of the aforementioned upper limits.

In one aspect, the maximum duty cycle under natural convection exhibited by the hoist system of the present disclosure can be about 100%, 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, or 50%.

The hoist system 100 can be operated by operably connecting an appropriate electrical supply to the synchronous motor 112. The hoist system 100 can be suspended by attachment of either the load hook 106 or the system hook 108 to an anchor point that can support both the hoist system 100 and any load mounted thereon. A load can be attached either to the system hook 108 or the load hook 106. A controller, not shown, that is operably connected to the synchronous motor 112 can be used to control the movement and speed of the load line 104. Under load, the speed of the load line can be increased from 0 m/min to the maximum speed or any speed there between. The speed can also be reduced and maintained at 0 m/min under load and/or raised to speeds measured in mm/min. When the load hook 106 is mounted to an anchor point and the load attached to the system hook 108, the hoist system housing 102 moves along with the load as the load line is moved.

The alignments and configurations of the parts of the hoist system disclosed herein can be varied without departing from the scope of the present disclosure. Other embodiments of the hoist system set forth in the present disclosure will be apparent to those skilled in the art from their consideration of the specification and practice of the present disclosure disclosed in this document. It is intended that the specification and examples be considered as exemplary only, with the true scope and spirit of the present disclosure being indicated by the following claims.

What is claimed is:

1. A hoist system comprising
a hoist system housing;
a load sheave mounted in the hoist system housing;
a load line operably engaged with the load sheave;
a hoist drive shaft operably connected to the load sheave;
a coupler connected to the hoist drive shaft, wherein the coupler comprises a first coupler end and a second coupler end opposing the first coupler end, the coupler further comprises a first coupler socket open to the first coupler end and a second coupler socket open to the second coupler end, wherein the second coupler socket comprises a key slot, and wherein at least a portion of the hoist drive shaft is disposed in the first coupler socket; and,
a synchronous motor connected to the coupler, wherein the synchronous motor comprises a motor drive shaft connected to the coupler, wherein the motor drive shaft comprises a key bit, wherein at least a portion of the motor drive shaft is disposed in the second coupler socket, and wherein at least a portion of the key bit is aligned in the key slot.

2. The hoist system of claim 1, wherein the coupler comprises a plurality of coupler splines projecting inwardly from a first coupler socket inner wall.

3. The chain hoist of claim 2, wherein the hoist drive shaft comprises a plurality of shaft splines projecting from the hoist drive shaft, and wherein the plurality of shaft splines mates with the plurality of coupler splines.

4. The chain hoist of claim 1, wherein the coupler comprises a first coupler end outer wall and a second coupler end outer wall, wherein the first coupler end outer wall comprises a first coupler end outer wall diameter and the second coupler end outer wall comprises second coupler end outer wall diameter, and wherein the first coupler end outer wall diameter is less than the second coupler end outer wall diameter.

5. The hoist system of claim 1, wherein the hoist drive shaft, the coupler and the synchronous motor are disposed in the hoist system housing.

6. The hoist system of claim 1, wherein the first socket is in communication with the second socket.

7. The hoist system of claim 1, wherein the synchronous motor is operable under natural convection with the load line supporting a load of about 1,000 kg.

8. The hoist system of claim 1, wherein the load line is movable under a load in a range of about 0 kg to about 1,000 kg at a speed in a range of about 0 m/min to about 20 m/min.

9. The hoist system of claim 1, wherein the load line is movable under a load in a range of about 0 kg to about 500 kg at a speed in a range of about 0 m/min to about 40 m/min.

10. A hoist system comprising:
a load sheave;
a load line operably engaged with the load sheave;
a hoist drive shaft operably connected to the load sheave, and wherein the hoist drive shaft comprises a plurality of shaft splines projecting radially;
a coupler connected to the hoist drive shaft, wherein the coupler comprises a first coupler end and a second coupler end opposing the first coupler end, wherein the coupler further comprises a first coupler socket open to the first coupler end and a second coupler socket open to the second coupler end, wherein the first coupler socket comprises a plurality of coupler splines projecting inwardly from a first coupler socket inner wall; and wherein the second coupler socket comprises a key slot formed in a second coupler socket inner wall, and wherein a portion of the hoist drive shaft is aligned in the first coupler socket; and,
a synchronous motor connected to the coupler, wherein the synchronous motor comprises a motor drive shaft connected to the coupler, wherein the motor drive shaft comprises a key bit, wherein at least a portion of the motor drive shaft is aligned in the second coupler socket, and wherein at least a portion of the key bit is aligned in the key slot.

11. The hoist system of claim 10, further comprising a hoist system housing, wherein the load sheave, the hoist drive shaft, and the coupler are disposed in the hoist system housing.

12. The hoist system of claim 11, wherein the synchronous motor is disposed in the hoist system housing.

13. The chain hoist of claim 10, wherein the coupler comprises a first coupler end outer wall and a second coupler end outer wall, wherein the first coupler end outer wall comprises a first coupler end outer wall diameter and the second coupler end outer wall comprises second coupler end outer wall diameter, and wherein the first coupler end outer wall diameter is less than the second coupler end outer wall diameter.

14. The hoist system of claim 10, wherein the synchronous motor is operable under natural convection with the load line supporting a load of about 1,000 kg.

15. The hoist system of claim 10, wherein the load line is movable under a load in a range of about 0 kg to about 1,000 kg at a speed in a range of about 0 m/min to about 20 m/min.

16. The hoist system of claim 10, wherein the load line is movable under a load in a range of about 0 kg to about 500 kg at a speed in a range of about 0 m/min to about 40 m/min.

17. A hoist system comprising:
a hoist system housing;
a load sheave disposed in the hoist system housing;
a load line operably engaged with the load sheave;
a hoist drive shaft operably connected to the load sheave, and wherein the hoist drive shaft comprises a plurality of shaft splines projecting from the hoist drive shaft;
a coupler connected to the hoist drive shaft, wherein the coupler comprises a first coupler end and a second coupler end opposing the first coupler end, wherein coupler comprises a first coupler end outer wall and a second coupler end outer wall, wherein the first coupler end outer wall comprises a first coupler end outer wall diameter and the second coupler end outer wall comprises second coupler end outer wall diameter, wherein the first coupler end outer wall diameter is less than the second coupler end outer wall diameter, wherein the coupler further comprises a first coupler socket open to the first coupler end and a second coupler socket open to the second coupler end, wherein the first coupler socket comprises a plurality of coupler splines projecting inwardly from a first coupler socket inner wall; wherein the second coupler socket comprises a key slot formed in a second coupler socket inner wall, and wherein a portion of the hoist drive shaft is aligned in the first coupler socket and the plurality of shaft splines mates with the plurality of coupler splines, and,
a synchronous motor connected to the coupler, wherein the synchronous motor comprises a motor drive shaft connected to the coupler, wherein the motor drive shaft comprises a key bit, wherein a portion of the motor drive shaft is aligned in the second coupler socket, and wherein a portion of the key bit is aligned in the key slot.

18. The hoist system of claim 17, wherein the first coupler socket inner wall comprises a first coupler socket inner wall diameter and the second coupler socket inner wall comprises a second coupler socket inner wall diameter, and wherein the second coupler socket inner wall diameter is greater than the first coupler socket inner wall diameter.

19. The hoist system of claim 17, wherein the load line is movable under a load in a range of about 0 kg to about 1000 kg at a speed in a range of about 0 m/min to about 20 m/min.

20. The hoist system of claim 17, wherein the load line is movable under a load in a range of about 0 kg to about 500 kg at a speed in a range of about 0 m/min to about 40 m/min.
